(19) United States
(12) Patent Application Publication
(10) Pub. No.: US 2020/0126412 A1
(43) Pub. Date: Apr. 23, 2020

(54) EMERGENCY VEHICLE PROXIMITY ALERT SYSTEM

(71) Applicant: BRADLEY JAMES, BRIBIE ISLAND (AU)

(72) Inventor: BRADLEY JAMES, BRIBIE ISLAND (AU)

(21) Appl. No.: 16/656,622

(22) Filed: Oct. 18, 2019

(30) Foreign Application Priority Data
Oct. 19, 2018 (AU) 2018903969

(51) Int. Cl. G08G 1/087; G08B 5/36; H04B 17/318

(52) U.S. Cl. CPC G08G 1/087; H04B 17/318; G08B 5/36

(57) ABSTRACT

An emergency vehicle proximity alert system including: at least one emergency vehicle fitted with a transmitter assembly for producing a transmission whilst the emergency vehicle is in transit to an emergency site; and at least one receiver assembly for receiving the transmission fitted to a corresponding at least one traffic light located along one or more vehicle routes for travel by the at least one emergency vehicle, wherein upon the transmission from the emergency vehicle being detected by the receiver assembly or being detected at above a predetermined threshold, the receiver assembly operates a visual alert to thereby alert road users to the presence of the emergency vehicle.

### CROSS REFERENCE TO RELATED APPLICATIONS

### Related Applications

The present application claims priority from Australian provisional patent application No. 2018903969 filed 19 Oct. 2019, the disclosure of which is hereby incorporated in its entirety by reference.

### TECHNICAL FIELD

The present invention concerns methods and systems for prioritizing the movement of emergency vehicles such as ambulances, fire engines, police cars and the like through dense traffic and in particular across controlled road intersections.

### BACKGROUND OF THE INVENTION

Emergency vehicle drivers and attendant staff are under great pressure to arrive at the site of an emergency to which they have been called as quickly as possible. With a view to improving transit times the emergency vehicles are fitted with visual and audible alarms so that other traffic users are alerted to their oncoming presence and can take action to clear the road in order to make a path for the emergency vehicle to advance through. In addition to the use of a siren and flashing lights fitted on the emergency vehicles, in recent years it has become known to track emergency vehicles with GPS at a central server that is interfaced to the traffic control network and to change the state of traffic lights as the emergency vehicle approaches in order that the most probable route between the emergency vehicle and the emergency site is kept open, i.e. traffic lights along the route change to green as the emergency vehicle approaches. However, such a system is highly complex and involves interfacing with the traffic management system and altering the traffic lights' state from their normal condition. Furthermore, such a system does not alert a motorist of the approaching emergency vehicle to a nearby intersection. It is also the case that in built up areas, traffic congestion may be such that drivers cannot move through an intersection even they are presented with a green light from traffic lights of the intersection.

It would be desirable if a more direct and less complex system were provided for assisting in reducing the transit time for an emergency vehicle to reach its destination emergency site through traffic. It is an object of the present invention to provide such a system.

### SUMMARY OF THE INVENTION

According to a first aspect of the present invention there is provided an emergency vehicle proximity alert system comprising:

at least one emergency vehicle fitted with a transmitter assembly for producing a transmission whilst the emergency vehicle is in transit to an emergency site; and

at least one receiver assembly for receiving the transmission fitted to a corresponding at least one traffic light located along one or more vehicle routes for travel by the at least one emergency vehicle;

wherein upon the transmission from the emergency vehicle being detected by the receiver assembly or being detected at above a predetermined threshold, the receiver assembly operates a visual alert to thereby alert road users to the presence of the emergency vehicle.

Preferably the system includes the visual alert, wherein the visual alertis coupled to the receiver assembly.

Preferably the receiver assembly is coupled to a directional antenna for receiving the transmission.

In a preferred embodiment of the invention the transmission is a radio frequency transmission. For example, the transmission may be in the ultra-high-frequency (UHF) or microwave bands. However it is possible that laser frequency transmissions may be used too.

It is preferable that a transmitter of the transmitter assembly is arranged to respond to an operator alarm switch that also operates an emergency vehicle alarm assembly of the emergency vehicle whereby upon an operator of the emergency vehicle operating the alarm switch the emergency vehicle alarm assembly and the transmitter are simultaneously operated.

The receiver assembly may include a signal strength detector which is arranged to generate an emergency vehicle proximity signal upon detecting a signal strength that is greater than a threshold value.

In a preferred embodiment of the invention the receiver assembly includes an alarm driver that is responsive to the signal strength detector.

Preferably the alarm driver is coupled to the visual alert for operation thereof.

In a preferred embodiment of the invention the receiver assembly and the visual alert are mounted to a set of traffic lights. However, it is possible in other embodiments of the invention that the visual alert and/or the receiver assembly could be mounted by a road side separately to a set of traffic lights.

According to another aspect of the present invention there is provided a method for improving the transit time of emergency vehicles through traffic comprising:

fitting each of the emergency vehicles with a transmitter assembly for generating a transmission;

installing a number of receiver assemblies and associated visual alerts along roads for use by the emergency vehicles wherein the receiver assemblies are arranged to detect the transmission;

operating the visual alerts in response to detection of the transmission by the receiver assemblies.

### BRIEF DESCRIPTION OF THE DRAWINGS

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way. The Detailed Description will make reference to a number of drawings as follows:

FIG. 1 is a diagram showing a system according to an embodiment of the present invention in operation.

FIG. 2 is a block diagram of a receiver assembly for fitting at a roadside position such as a set of traffic lights according to the embodiment of invention.

FIG. 3 is a flowchart of the operation of a receiver assembly according to an embodiment of the present invention.

FIG. 4 shows a receiver assembly with visual alerts, comprising an alarm assembly that includes light sources, and antenna according to an embodiment of the present invention for installation on a traffic light.

FIG. 5 is a block diagram of a transmitter assembly for fitting to an emergency vehicle.

FIG. 6 is a stylized plan view of an intersection without the system having been installed.

FIG. 7 depicts the intersection with the system installed thereby illustrating the efficacy of the system.

### DETAILED DESCRIPTION OF THE INVENTION

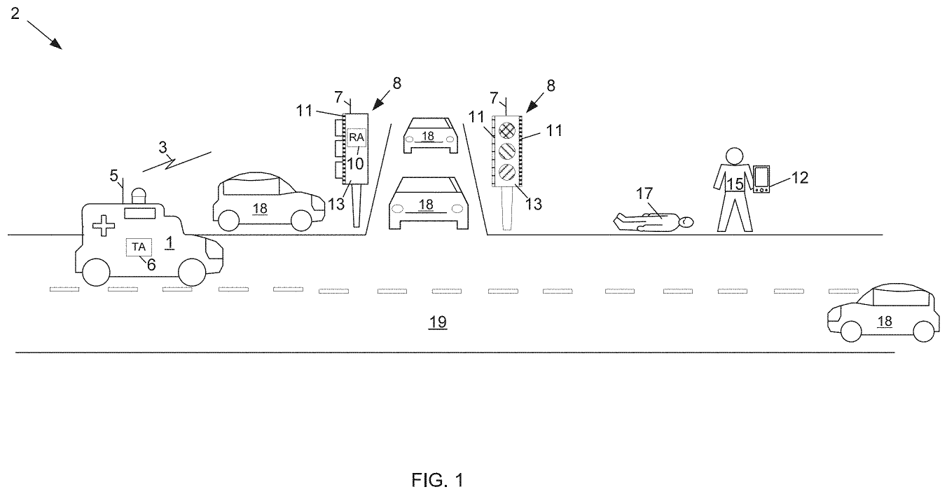

FIG. 1 depicts an emergency vehicle proximity alert system 2 according to a preferred embodiment of the present invention in use. The system includes at least one emergency vehicle in the form of ambulance 1 equipped with a transmitter assembly 6 that radiates an electromagnetic signal 3 via antenna 5 to which the transmitter assembly 6 is coupled. In the presently described preferred embodiment the system further includes at least one alert assembly 8 which comprises an antenna 7, receiver assembly 10 and visual alert in the form of a visual alarm assembly 11 comprising warning lights 11a, 11b, all mounted to a conventional traffic light 13. In other embodiments the system may make use of lights that are already present at the site to provide the visual alert.

In the scenario illustrated in FIG. 1, the ambulance 1 has been called by a passerby 15, for example by means of mobile phone 12 to assist an injured person 17. As the ambulance 1 enters an area surrounding alert assembly 8, its receiver assembly 10 detects transmission of the electromagnetic signal 3 from the transmitter assembly 6 of the ambulance 1 and activates the visual alert in the form of warning lights 11a, 11b of the visual alarm assembly 11 so that they flash and thereby alert vehicles 18 to keep the road 19 clear for the ambulance 1 thereby reducing travel time for the ambulance 1 to reach the injured person 17.

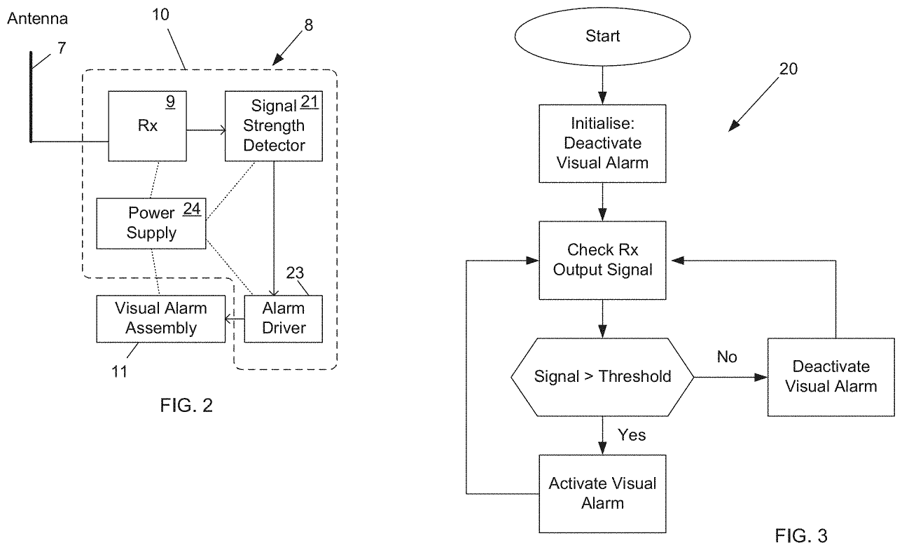

FIG. 2 is a block diagram of the alert assembly 8. The alert assembly 8 includes antenna 7 which is coupled to the receiver assembly 10 which in turn drives the visual alert comprising lights 11a, 11b of visual alarm assembly 11. The receiver assembly 10 includes a radio frequency receiver 9. The radio frequency receiver 9 is coupled to a signal strength detector 21. For example, the antenna 7 and receiver 9 may be arranged for detecting a transmission such as a frequency modulated (FM) signal in a reserved frequency range of a transmission band such as the UHF band. Higher frequency bands, for example in the GHz range may also be used if it is desired to strictly limit the operational range to line-of-sight. The signal strength detector 21 monitors the output from the receiver 9 and once the received signal exceeds a predetermined threshold activates an alarm driver 23 which in turn switches on the visual alarm assembly 11 so that light 11a, 11b provide the visual alert. The predetermined threshold is found by testing and calibrating the system to settle on a threshold value that is appropriate for a desired range. For example, if the desired range for the alarm to be triggered is 200 meters then all else being equal the threshold value will be lower than if the desired range is 150 metres. Preferably the range is 100 m to 300 m.

Signal strength detectors are known in the prior art. For example, the signal strength detector 21 may include a tuned circuit such as an LC circuit that is coupled to the antenna with a detector, for example a diode and capacitor coupled to the tuned circuit and a buffer stage such as a FET or other high input impedance device that is coupled to the detector. An output from the buffer may be metered with, for example, a bridge circuit and a thresholding op-Amp. Consequently, once the detected field strength exceeds the threshold the signal strength detector 21 sends a signal to the alarm driver 23 which then activates the visual alert in the form of the visual alarm assembly 11 that comprises lights 11a, 11b. The various components of the alert assembly 8 are powered by a suitable power supply 24.

In an alternative embodiment of the invention the signal strength detector 21 may be implemented digitally, for example as a suitably programmed processor that includes an analog-to-digital converter that monitors the output from the receiver 9. In that case the processor is programmed to implement the procedure that is illustrated in the flowchart 20 of FIG. 3.

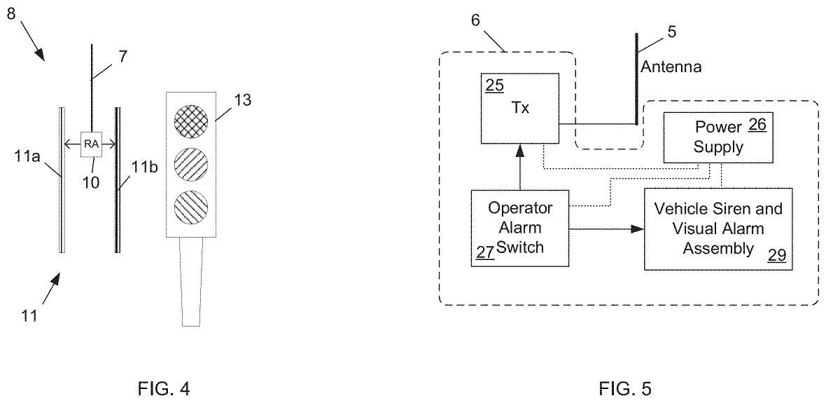

FIG. 4 shows the alert assembly 8 prior to its installation on traffic light 13. The visual alert, in the form of visual alarm assembly 11 is comprised of two elongate bars of light sources 11a, 11b such as colored LEDs that are arranged to flash or “strobe” in response to receiving a signal from the alarm driver 23 so that they are readily noticeable by motorists at a distance. In one embodiment the LEDs comprise red and blue LEDs or other similarly coloured light sources for particularly standing out to motorists over a distance of 200-300 m at night.

Referring now to FIG. 5, the transmitter assembly 6 includes a radio transmitter 25 with an RF output side that is coupled to an antenna 5. Antenna 5 and transmitter 25 are arranged for generating a transmission such as a frequency modulated (FM) signal in a reserved range of a transmission band such as the ultra-high frequency (UHF) band. Whatever transmission scheme is chosen it must be ensured that the receiver assembly 10 and the transmitter assembly 6 are properly paired so that the receiver assembly 10 can detect transmissions from the transmitter assembly 6 once the vehicle 1 to which the transmitter assembly 6 is fitted is sufficiently close. The radio transmitter 25 and receiver assembly 10 are calibrated so that the signal strength detector 21 detects the transmissions from the transmitter assembly 6 once the vehicle is within a predetermined range, for example 150 meters line of sight. The various components of the transmitter assembly are powered by a suitable power supply 26.

Transmitter 25 is activated by an operator alarm switch 27 that also activates the emergency vehicle's siren and emergency vehicle visual alarm assembly 29. Therefore, once the driver of the emergency vehicle 1 makes a decision to operate the alarm switch to activate the siren and emergency vehicle visual alarm 29 the transmitter 25 will also be activated.

It is preferable that the transmit antenna 5 is somewhat directional with a line-of-sight pointing in the forward direction of the vehicle so that activation of alarm assemblies to the rear and side of the vehicle is minimised.

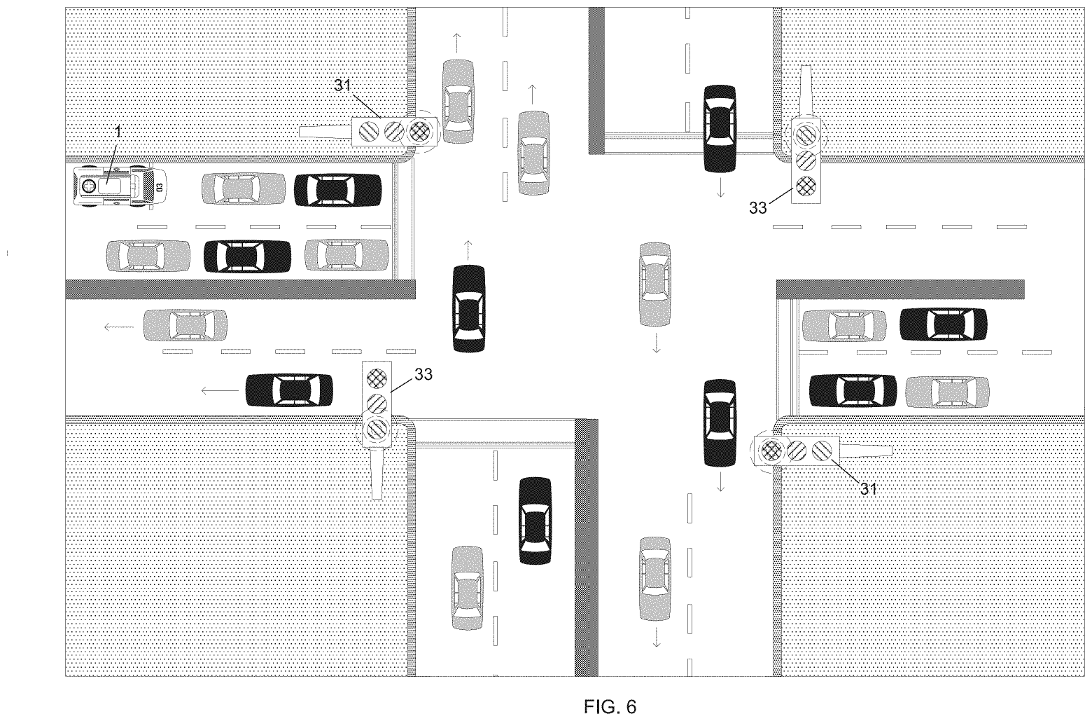

FIG. 6 is a somewhat stylised aerial view of a busy intersection without an emergency vehicle alert system according to an embodiment of the present invention being fitted. It will be observed that emergency vehicle 1 is stopped behind a number of cars with the traffic lights 31 showing a red “stop” signal. The traffic lights 33 on the cross road show a green “go” signal so that a number of vehicles are proceeding across the intersection.

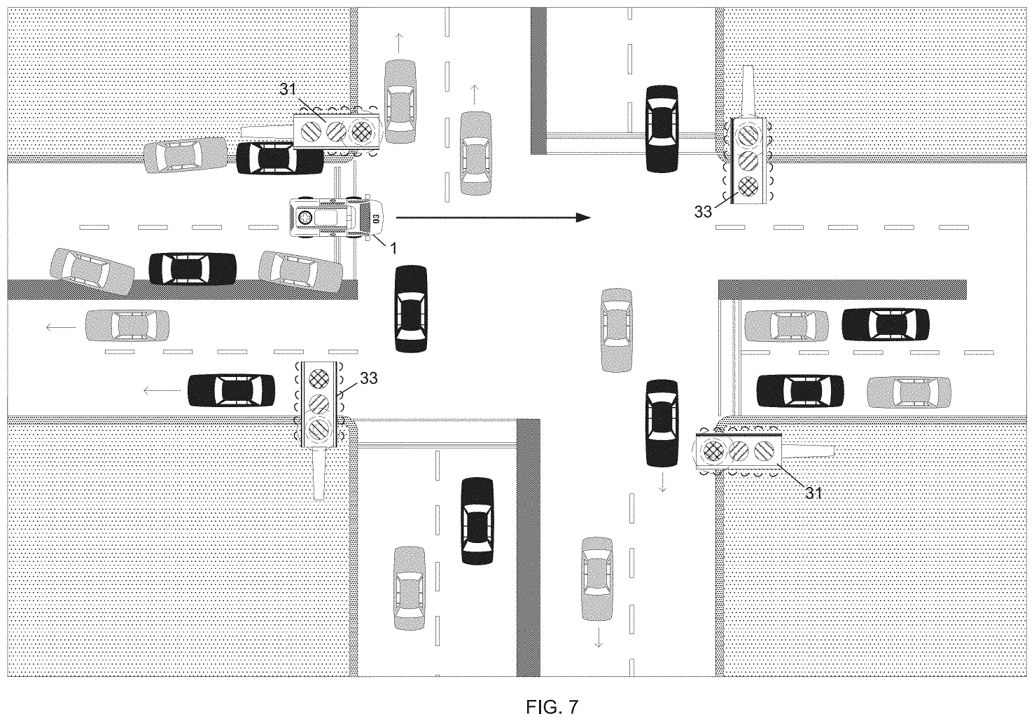

FIG. 7 shows the same intersection as of FIG. 6 but with the alert assembly 8 fitted to each of the traffic lights. The driver of emergency vehicle 1 has activated the vehicle's transmitter which in turn has caused the warning light assemblies 11a, 11b on each of the traffic lights 33 to operate thereby warning the other vehicles of the approaching emergency vehicle 1. In response the other vehicles have pulled to a side of the road and halted so as to open a path for the emergency vehicle 1 to proceed through.

An advantage of the alert system 2 according to an embodiment of the present invention is that it greatly reduces the possibility of an emergency vehicle that is a party to the system being involved in a collision at an intersection that is also part of the system.

A further advantage is that the system 2 that has been described will operate even if the traffic lights malfunction since the system operates independently of the traffic lights.

It will be realised that the system 2 that has been described is relatively simple to implement since it does not rely on GPS and data networking infra-structure to monitor the position of emergency vehicles, predict paths and change the state of traffic lights along those paths.

In compliance with the statute, the invention has been described in language more or less specific to structural or methodical features. The term “comprises” and its variations, such as “comprising” and “comprised of” is used throughout in an inclusive sense and not to the exclusion of any additional features. It is to be understood that the invention is not limited to specific features shown or described since the means herein described comprises preferred forms of putting the invention into effect. The invention is, therefore, claimed in any of its forms or modifications within the proper scope of the appended claims appropriately interpreted by those skilled in the art.

Throughout the specification and claims (if present), unless the context requires otherwise, the term “substantially” or “about” will be understood to not be limited to the value for the range qualified by the terms.

Any embodiment of the invention is meant to be illustrative only and is not meant to be limiting to the invention. Therefore, it should be appreciated that various other changes and modifications can be made to any embodiment described without departing from the spirit and scope of the invention.

Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith.

What is claimed is:

1. An emergency vehicle proximity alert system comprising:
at least one emergency vehicle fitted with a transmitter assembly for producing a transmission whilst the emergency vehicle is in transit to an emergency site; and
at least one receiver assembly for receiving the transmission fitted to a corresponding at least one traffic light located along one or more vehicle routes for travel by the at least one emergency vehicle;
wherein upon the transmission from the emergency vehicle being detected by the receiver assembly or being detected at above a predetermined threshold, the receiver assembly operates a visual alert to thereby alert road users to the presence of the emergency vehicle.

2. The system of claim 1 including the visual alert wherein the visual alert is coupled to the receiver assembly.

3. The system according to claim 2, wherein the receiver assembly is coupled to a directional antenna for receiving the transmission.

4. The system according to claim 1, wherein the transmission is a radio frequency transmission.

5. The system according to claim 4, wherein the transmission is in an ultra-high-frequency (UHF) or microwave band.

6. The system according to claim 1, wherein a transmitter of the transmitter assembly is arranged to respond to an operator alarm switch that also operates an emergency vehicle alarm assembly of the vehicle whereby upon an operator of the vehicle operating the alarm switch the emergency vehicle alarm assembly and the transmitter are simultaneously operated.

7. The system according to claim 1, wherein the receiver assembly includes a signal strength detector which is arranged to generate an emergency vehicle proximity signal upon detecting a signal strength that is greater than a threshold value.

8. The system according to claim 6, wherein the receiver assembly includes a signal strength detector which is arranged to generate an emergency vehicle proximity signal upon detecting a signal strength that is greater than a threshold value.

9. The system according to claim 7, wherein the receiver assembly includes an alarm driver that is responsive to the signal strength detector.

10. The system according to claim 8, wherein the receiver assembly includes an alarm driver that is responsive to the signal strength detector.

11. The system according to claim 9, wherein the alarm driver is coupled to the visual alert for operation thereof.

12. The system according to claim 10, wherein the alarm driver is coupled to the visual alert for operation thereof.

13. The system according to claim 1, wherein the receiver assembly and the visual alert are mounted to a set of traffic lights.

14. The system according to claim 13, wherein the receiver assembly and the visual alert are mounted to a set of traffic lights.

15. A method for improving the transit time of emergency vehicles through traffic comprising:
fitting each of the emergency vehicles with a transmitter assembly for generating a transmission;
installing a number of receiver assemblies and associated visual alerts along roads for use by the emergency vehicles wherein the receiver assemblies are arranged to detect the transmission;
operating the visual alerts in response to detection of the transmission by the receiver assemblies to thereby alert road users to the presence of the emergency vehicle.
